(19) United States
(12) Patent Application Publication
(10) Pub. No.: US 2013/0073326 A1
(43) Pub. Date: Mar. 21, 2013

(54) Management of Compliance with Policies, Procedures and/or Directives

(71) Applicants: Bradley W. Jordan, Glencoe, MO (US); Alice M. Lawrence, Wildwood, MO (US); A. Martin Hansen, Chesterfield, MO (US)

(72) Inventors: Bradley W. Jordan, Glencoe, MO (US); Alice M. Lawrence, Wildwood, MO (US); A. Martin Hansen, Chesterfield, MO (US)

(73) Assignee: Jordan Lawrence Group, L.C., St. Louis, MO (US)

(21) Appl. No.: 13/235,979

(22) Filed: Sep. 19, 2011

(51) Int. Cl. G06Q 10/00

(52) U.S. Cl. 705/7.11

(57) ABSTRACT

A system for overseeing implementations of organizational policies, procedures, and/or directives. A host identifies parties involved in the implementations and tracks implementation statuses by (a) issuing notices for access by the identified parties, (b) with each notice, providing actions selectable as a response to the notice, and (c) tracking responses by the identified parties. In response to a predefined event, a user device associated by the host with one of the identified parties polls the host to determine whether a notice is pending for the associated party, and if so, provides an alert. Based on a user response to the alert, the user device displays the pending notice via a browser, and sends to the host via the browser a user-selected response to the pending notice. The host leaves the notice pending until the host receives a user-selected response.

### FIELD

The present disclosure relates to management of compliance with policies, procedures and/or directives issued, for example, by an enterprise, company or other organization.

### BACKGROUND

This section provides background information related to the present disclosure which is not necessarily prior art.

In most companies, management oversees the communication of policies and procedures to employees and monitors employee compliance. Communication of policies, procedures and directives typically takes the form of email to employees, who may be widely dispersed geographically.

### SUMMARY

This section provides a general summary of the disclosure, and is not a comprehensive disclosure of its full scope or all of its features.

The present disclosure, in one implementation, is directed to a system for overseeing the implementation of policies, procedures, and/or directives of an organization. A host is configured to identify parties involved in implementations of policies, procedures, and/or directives of an organization. The host is further configured to track statuses of the implementations by (a) issuing implementation notices for access by the identified parties, (b) providing with each notice one or more actions selectable as a response to the notice, and (c) tracking responses by the identified parties. A user device is associated by the host with one of the identified parties. In response to an occurrence of a predefined event, the user device polls the host to determine whether an implementation notice is pending for the associated one of the identified parties and provide an alert if an implementation notice is determined to be pending. Based on a user response to the alert, the user device displays the pending notice via a browser of the user device, and sends to the host via the browser a user-selected response, if any, to the pending notice. The host is further configured to leave the pending notice pending until the host receives a user-selected response.

In another implementation, the disclosure is directed to a method of overseeing the implementation of policies, procedures, and/or directives of an organization. A host that includes a processor and memory identifies parties involved in implementations of policies, procedures, and/or directives of an organization. The host tracks statuses of the implementations by (a) issuing implementation notices for access by the identified parties, (b) including in each notice one or more links selectable as a response to the notice, (c) tracking responses received from user devices associated with the identified parties and registered with the host, and (d) leaving an issued implementation notice pending unless and until a response to the notice is received. In response to an occurrence of a predefined event, a user device associated with one of the identified parties polls the host to determine whether an implementation notice by the host is pending for the associated one of the identified parties. The user device provides an alert if an implementation notice is determined to be pending. Based on a user response to the alert, the user device displays the notice via a browser of the device. The user device communicates to the host via the browser a response, if any, via a link selected by the user in the displayed notice. The host updates a status of the notice based on the responses, if any, to the alert and/or to the notice.

In yet another implementation, the disclosure is directed to a system for overseeing the implementation of policies, procedures, and/or directives of an organization. A host is configured to identify parties involved in implementations of policies, procedures, and/or directives of an organization. The host is further configured to track statuses of the implementations by (a) issuing implementation notices for access by the identified parties, (b) including in each notice one or more links selectable as a response to the notice, (c) tracking responses by the identified parties, and (d) leaving an issued implementation notice pending unless and until a response to the notice is received. A user device is associated by the host with one of the identified parties. In response to an occurrence of a predefined event, the user device polls the host to determine whether an implementation notice is pending for the user device and provides an alert if an implementation notice is determined to be pending. Based on a user response to the alert, the user device displays the pending notice via a browser of the user device, and transmits to the host via the browser and one of the links a user-selected response, if any, to the pending notice.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a system for overseeing the implementation of policies, procedures and/or directives of an organization in accordance with one implementation of the disclosure;

FIG. 2 is a flow diagram of a method of enforcing compliance with policies and/or directives of an organization in accordance with one implementation of the disclosure;

FIG. 3A is a flow diagram of a mobile application start process in accordance with one implementation of the disclosure;

FIG. 3B is a flow diagram of a context menu process in accordance with one implementation of the disclosure;

FIG. 3C is a screen shot of a mobile application menu display in accordance with one implementation of the disclosure;

FIG. 3D is a flow diagram of a display notice process in accordance with one implementation of the disclosure;

FIG. 3E is a flow diagram of a user registration process of a mobile application in accordance with one implementation of the disclosure;

FIG. 3F is a flow diagram of a push notification registration process in accordance with one implementation of the disclosure;

FIG. 3G is a flow diagram of a push notification process in accordance with one implementation of the disclosure;

FIG. 3H is a screen shot of a mobile application alert list in accordance with one implementation of the disclosure;

FIG. 4A is a flow diagram of an application start process in accordance with one implementation of the disclosure;

FIG. 4B is a flow diagram of a user registration process in accordance with one implementation of the disclosure;

FIG. 4C is a flow diagram of a context menu process in accordance with one implementation of the disclosure;

FIG. 4D is a flow diagram of a display notice process in accordance with one implementation of the disclosure;

FIG. 4E is a screen shot of a menu display in accordance with one implementation of the disclosure;

FIG. 4F is a screen shot of an alert popup in accordance with one implementation of the disclosure;

FIG. 4G is a screen shot of an active holds list in accordance with one implementation of the disclosure; and

FIG. 5 is a flow diagram of a method of sending a message in accordance with one implementation of the disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The present disclosure, in some implementations, is directed to a system for overseeing the implementation of policies, procedures, and/or directives of an enterprise, company or other organization. In most business organizations, management oversees the communication of policies, procedures and directives to employees. Management also is typically responsible for compliance by employees with policies, procedures and directives. Most companies currently use email to facilitate compliance.

In various implementations of the present disclosure, a system is provided for distributing to employees communications of and/or relating to policies, procedures and/or directives, and for tracking whether employees have received, read and/or responded to the communications. The system also can provide management with a means for auditing compliance with such communications. It should be noted that in various implementations of the disclosure, it is not necessary to communicate notices of policies, procedures and/or directives to employees by email, nor is it necessary for employees to send email to respond to such notices.

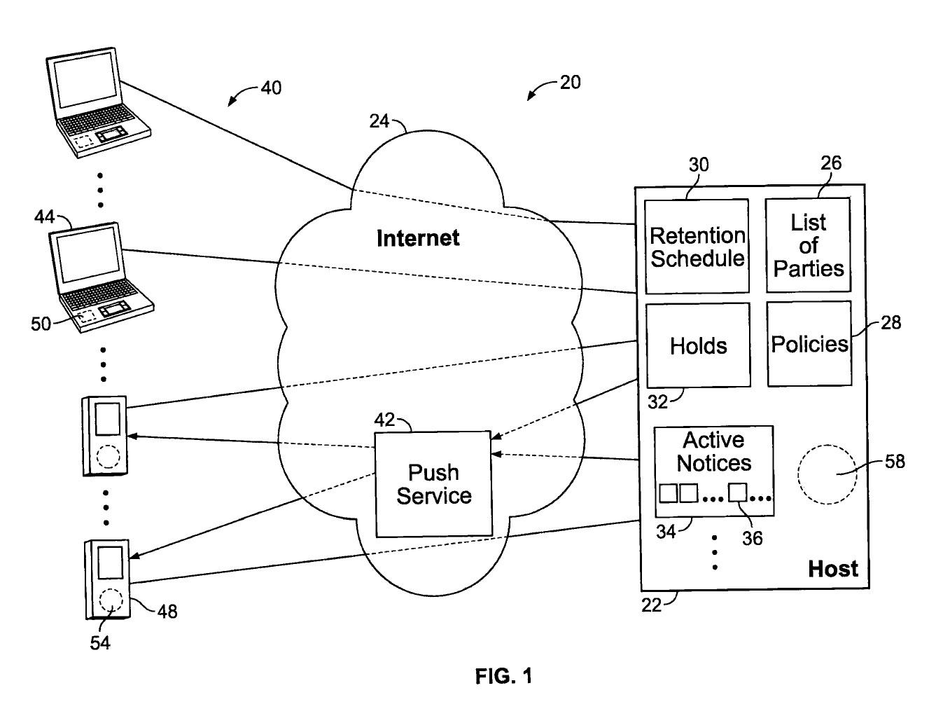

One configuration of a system for overseeing the implementation of policies, procedures and/or directives of an organization is indicated schematically in FIG. 1 by reference number 20. The system 20 includes a host 22, which may include one or more servers, routers, personal computers, combinations of the foregoing, various combinations of processors and memory, etc. It should be noted that many different device configurations could be used to provide the capabilities described herein. In one implementation the host 22 is configured and administered to provide policy management for a given organization. The host 22 may, but does not necessarily, reside behind a firewall and may or may not be part of an enterprise network. In some implementations the organization may access the host 22, e.g., through web services on the Internet 24.

The host 22 has, or has access to, a database 26 of employees and/or other parties who would carry out management policies, procedures and directives and/or are otherwise involved in implementing policies, procedures and/or directives of the organization. The host 22 also has, or has access to, a database 28 of current policies of the organization. Policies could pertain to a variety of matters, including but not limited to document management, privacy management, regulatory compliance, and/or litigation management. The host 22 has, or has access to, a database 30 in which a retention schedule is maintained for the purpose of controlling retention, location and disposal of documents and/or other items held by the organization.

The host 22 also has, or has access to, a database 32 of document hold orders for the purpose of complying with court orders and other requirements pertaining to litigation in which the organization may be involved. It should be noted that the foregoing databases and their subject matter are examples only. Other or additional types of data and/or databases could be maintained and/or used by an organization to administer various areas of interest in accordance with implementations of the disclosure. In some configurations the host 22 performs management functions as part of or in connection with a content management system such as SharePoint®, available from Microsoft®.

The host 22 has, or has access to, a database 34 of active notices 36 issued by the organization for delivery to various employees and/or other parties involved in implementing policies, procedures and/or directives of the organization. Such notices may pertain to communication and/or enforcement of policies, communication of and/or compliance with document hold orders, etc. A given notice 36 is intended to be read by one or more of the parties and typically requires a response from the recipient(s). In the present example system 20, the host 22 relates each of the notices 36 to a corresponding implementation category. Thus, for example, a notice 36 could be related to a retention schedule, a document hold schedule, or a policy schedule. The host 22 keeps track of whether a given notice 36 has been made available to, opened by and/or responded to by the intended recipient(s). It should be noted that the use of other or additional implementation categories is possible in various organizations.

Employees and/or other parties who are to read and respond to implementation notices 36 may be remote from the host 22, remote from a network maintained by the organization, and/or geographically dispersed. An insurance company, for example, might need to oversee the receipt of and compliance with policy directives by large numbers of insurance agents located in various areas of the country. Thus in the example implementation shown in FIG. 1, at least some of the parties who are to read and respond to implementation notices 36 have access to user devices referred to generally by reference number 40. A given device 40 is associated by the host 22 with a given party as further described below.

The user device 40 may be, e.g., an Internet-accessible laptop or desktop computer 44 or a mobile device 48. Other or additional types of devices may be used if configurable in accordance with principles of the present disclosure. A user device 40 may be, but is not necessarily, behind a firewall. Additionally or alternatively, a user device 40 may be, but is not necessarily, in communication with a push service 42 as further described below.

The devices 44 and 48 respectively have, or have access to, software applications 50 and 54, and the host 22 has, or has access to, a software application 58 configured to perform various functions described in this disclosure. It should be noted generally that the term “software application” is to be interpreted broadly in the present disclosure. A “software application” can take many forms, including but not limited to source, object, and/or executable code that can include and/or refer to a plurality of objects, modules, libraries, services, etc., and that can be stored, distributed, downloaded, combined and/or accessed in many different ways.

The devices 40 are configured to display alerts to users when active notices 36 are pending. The host application 58 tracks whether a user opened a notice 36, closed the notice 36 without responding, and/or responded to the host 22 as required. Activities related to a notice 36 are logged by the host application 58, e.g., via web services.

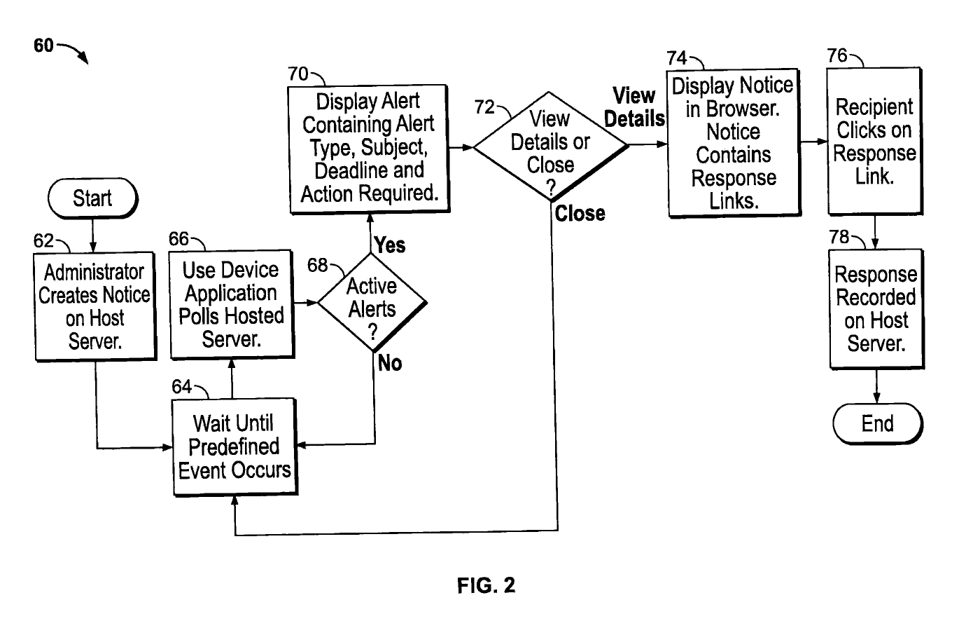

Enforcement of compliance with policies, procedures and/or directives may be automatically managed, e.g., using a method indicated in FIG. 2 by reference number 60. In process 62 a notice 36 is created, e.g., by an administrator of the system 20 in the database 34 for reading by one or more parties. A user device 40 polls the host 22 automatically in process 66 upon the occurrence of a predefined event in process 64. The type of predefined event may or may not depend on the type of user device 40. A laptop or desktop computer 44, for example, may poll the host 22 periodically and may wait in process 64 until an application timer expires. As another example, the application 54 of a mobile device 48 may remain inactive in process 64 until the device 48 receives a push notification from the push service 42 as further described below. As yet another example, a predefined event may be an activation by the user of a user device 40 of a menu option to poll the host 22 as further described below.

In process 66 a user device 40 polls the host 22 to determine whether there are any active alerts for the user on the host 22. Polling in process 66 is performed using SOAP or another web service messaging protocol. In such manner, the applications 50 and/or 54 can communicate with the host application 58 even if a firewall is present. If in process 68 one or more active alerts are pending on the host 22 for the user of the device 40, then in process 70 the user device 40 uses SOAP calls to pull HTML code, or code in some other markup language, from the host 22 for rendering the alerts and displays the alert(s). An alert may include, e.g., a brief message identifying an implementation category associated with the notice 36, subject matter of the notice 36, and action required from the user. An alert may be rendered, e.g., as a popup near the system tray of a desktop or laptop computer 44. Alerts may be rendered on a mobile device 48, e.g., as a list on the device screen.

In process 72, in order to view details of a notice 36, the user may, e.g., activate a “View Details” button or click on an alert displayed on the user device 40. The user device 40 responds in process 74 by displaying the complete notice 36 that corresponds to the selected alert. Specifically and for example, the device application 50 or 54 passes a temporary security token to the host 22 via SOAP and pulls the corresponding notice 36 from the host 22, as HTML or as written in another markup language. The device 40 launches a web browser, e.g., the default browser for the device 40, and the notice 36 is rendered on the user device 40 by the browser. The complete notice 36 includes one or more links selectable by the user to respond to the notice 36. If in process 76 the user activates a link, the user device 40 sends the response to the host 22 via the device 40 browser. In process 78 the host 22 records the user's response, e.g., in relation to the appropriate implementation category.

It should be noted that unless and until a user device 40 sends a user response to a given notice 36 pending for the user of the device 40, the given notice remains pending for that user. In such case, subsequent polling of the host 22 by the user device 40 will again result in an alert being displayed on the user device 40 for the given notice 36. The host 22 tracks whether a given alert was pulled from the host 22 for display on a given user device 40. The host 22 also tracks whether a notice 36 corresponding to a pulled alert was also pulled from the host by the given user device 40. Thus the statuses of notices 36 to which users have not responded may be monitored, and such notices 36 may be prevented from being prematurely deleted from the system 20.

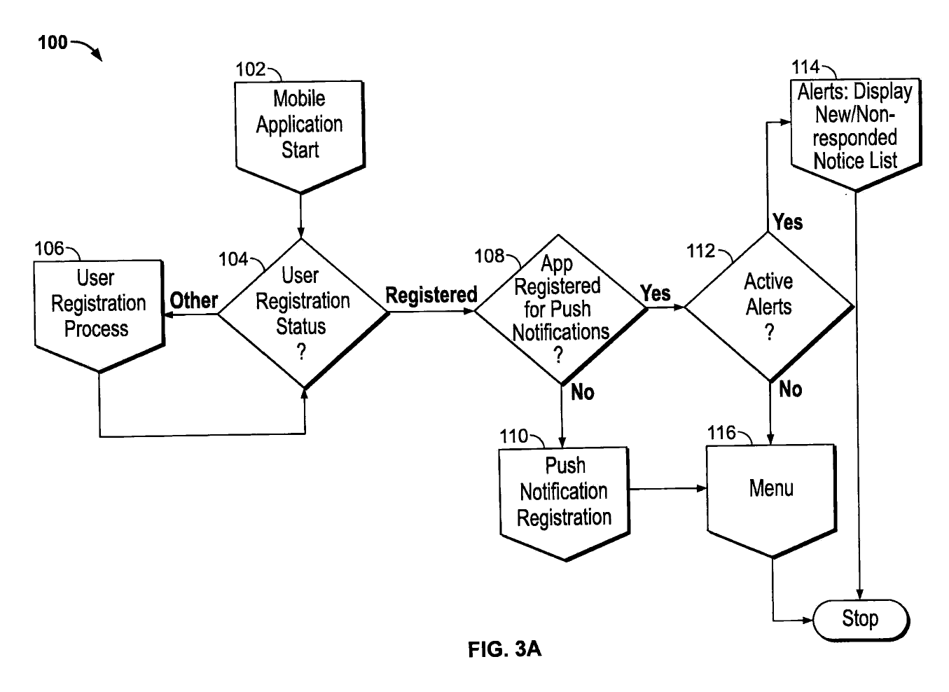

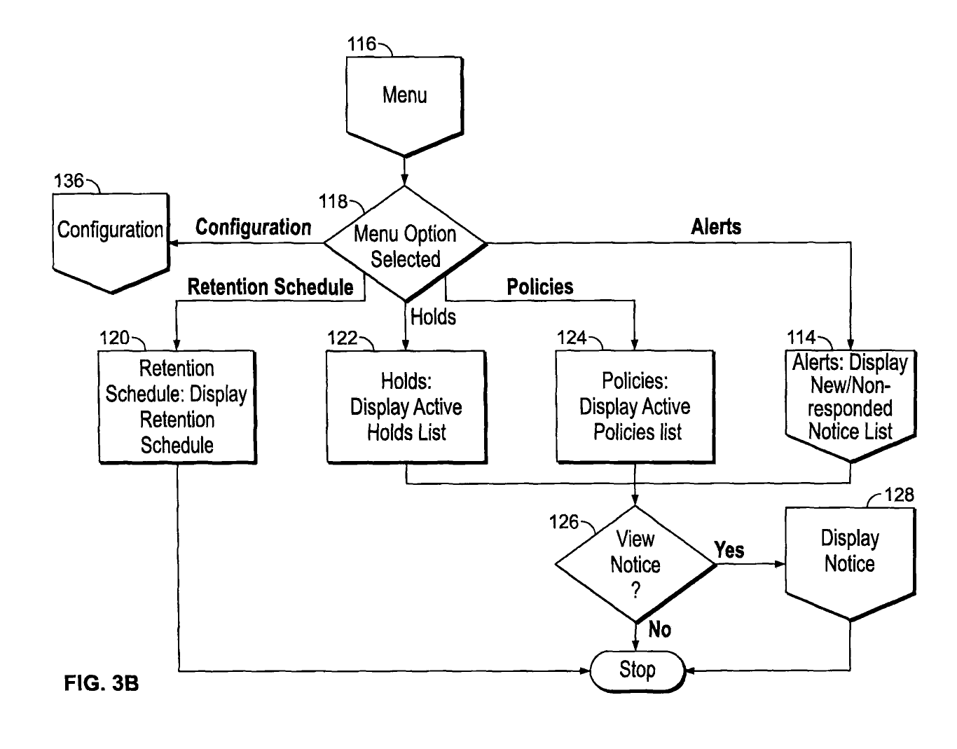

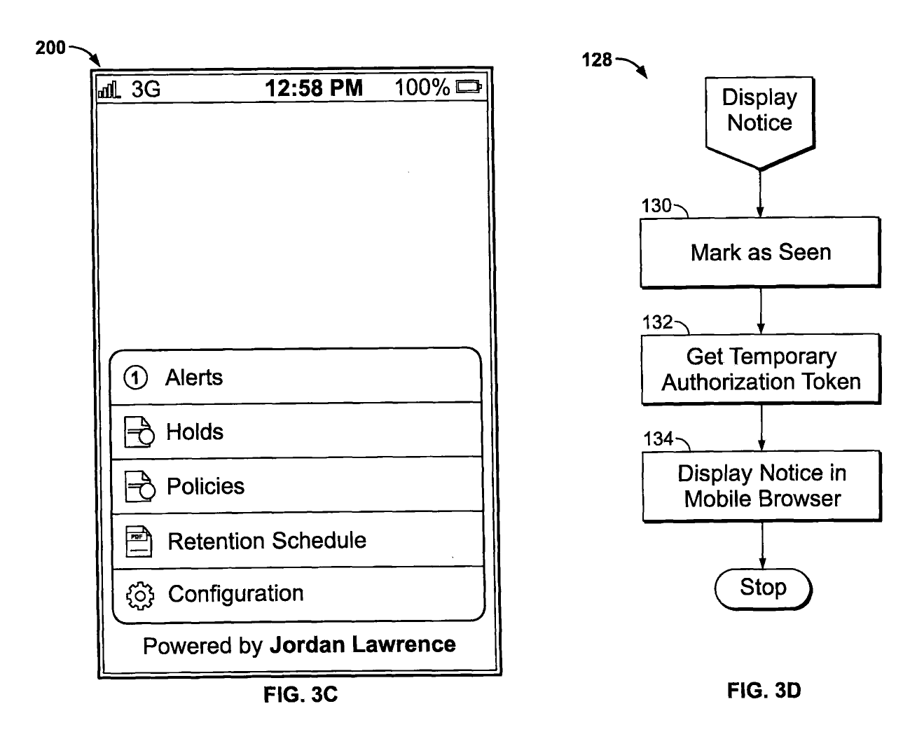

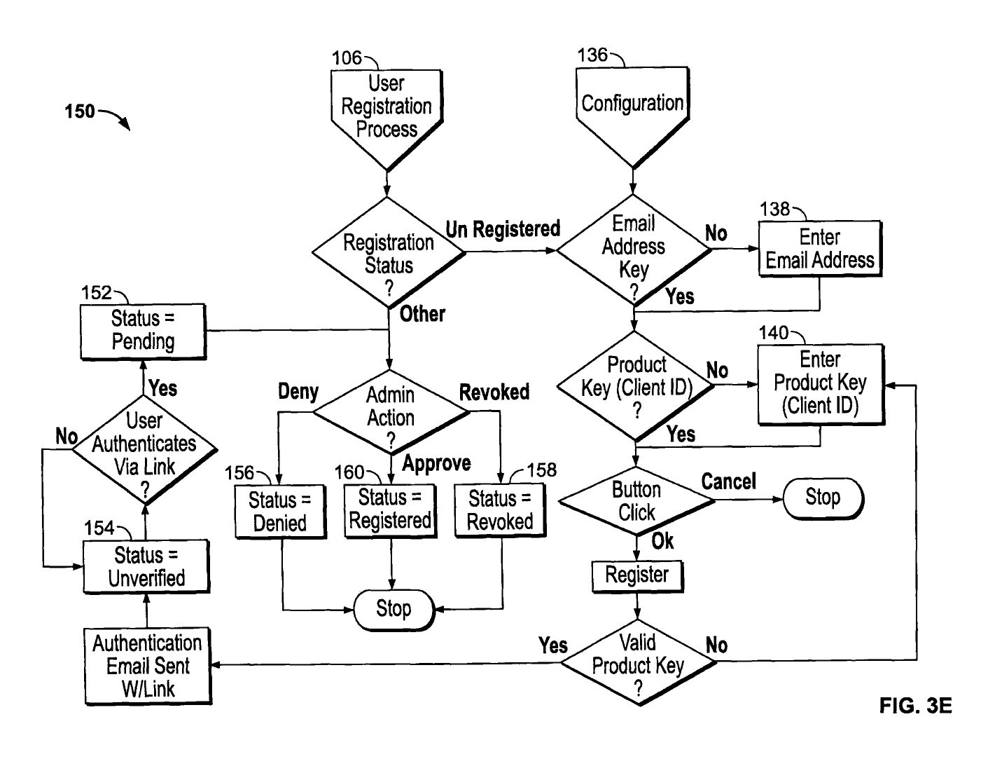

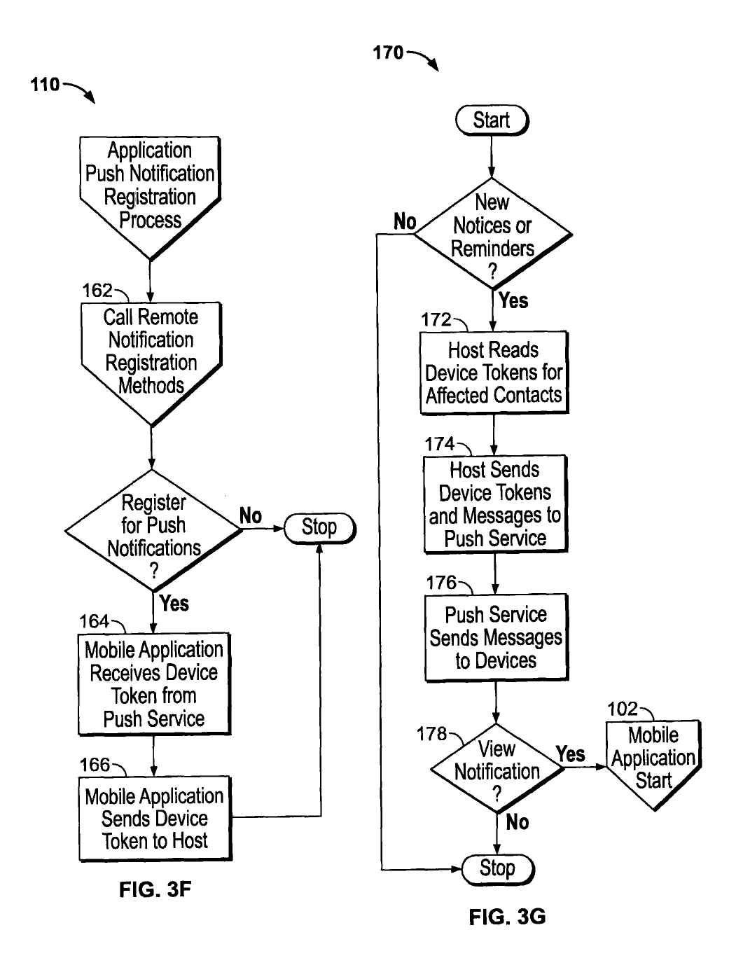

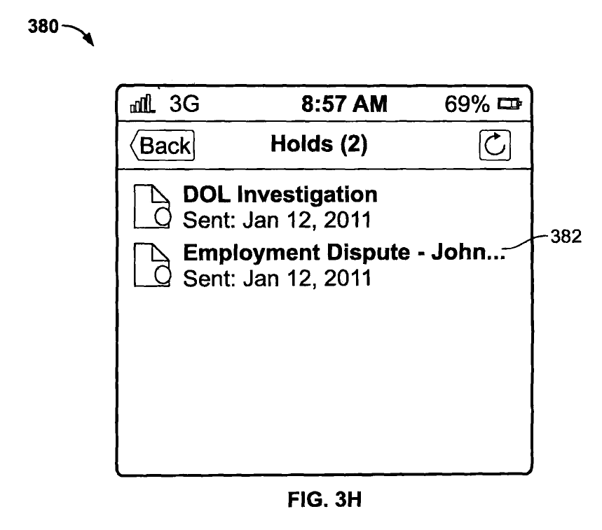

At least some of the foregoing processes discussed with reference to FIG. 2 may differ in some details in various implementations, dependent, e.g., on the type(s) of user device 40. In one implementation indicated generally in FIGS. 3A-3H by reference number 100, a mobile device 48 is configured as a user device 40. Specifically and for example, the software application 54 is loaded onto the mobile device 48 to communicate, through web services, with the application 58 hosted on the host 22. Communication through web services facilitates self-configuring by the software, thereby reducing or eliminating a need to update the software.

Referring to FIG. 1, the host 22 uses the push service 42 to notify the mobile device 48 that a notice 36 is pending for the associated party. Push services may be obtained, for example, from Apple® Push Notification Service (APNs), although other push services could be used. The software application may be written in Objective-C® from Apple Inc., although other languages may be used.

In the present example system 20, the host 22 establishes an accredited, encrypted and persistent Internet Protocol (IP) connection with the push service 42 and sends push notifications over the connection to the push service 42. Each mobile device 48 that is to receive push notifications from the push service 42 establishes its own accredited, encrypted, and persistent IP connection with the push service 42. The push service 42 transports and routes a push notification from the host 22 to the appropriate mobile device 48. If the mobile device software application 54 is not running at the time the mobile device 48 receives a push notification from the push service 42, the arrival of the push notification causes the software application 54 to open on the mobile device 48.

As shown in FIG. 3A, the mobile device software application 54 starts up in process 102. In process 104 the application 54 determines whether the user has already registered with and been approved by the host 22 to receive notices 36. If the user has not yet been approved, a user registration process may be performed in a process 106, e.g., as shown in FIG. 3E further described below. If the user has already registered with the host 22, then in process 108 the software application 54 on the mobile device 48 determines whether the application 54 has been registered with the push service 42 to receive push notifications. If not, then a push notification registration process may be performed in process 110, e.g., as shown in FIG. 3F further discussed below.

When the user and the mobile device application 54 have both been appropriately registered, then in process 112 the application 54 polls the host 22 for any active alerts pending for the mobile device 48. If there are active alerts pending, then the mobile device 48 displays a list of the active alerts in process 114 as shown in FIG. 3B. In the absence of any active alerts, and as shown in FIG. 3B, the application 54 in process 116 may display a menu of options on the mobile device 48 display. An example mobile device menu display is indicated generally in FIG. 3C by reference number 200.

Referring again to FIG. 3B, in process 118 the user may select from several menu options. In order to provide at least some of the features selectable from the menu, the software application 54 on the mobile device 48 communicates with the host 22 via web services to provide the features, including but not limited to scheduling and reporting capabilities. It should be noted generally that menu options could be provided in addition to, and/or in place of, those shown in FIGS. 3B and 3C. Such options could include capabilities cooperatively provided by a user device 40 and the host 22 through web services and web service protocols including but not limited to SOAP.

In process 120, if selected by the user, the application 54 may use one or more SOAP calls to poll the host 22 and pull from the host 22 the organization's current retention schedule. The schedule is rendered by a browser of the device 48. In process 122, if selected by the user, the application 54 may use SOAP calls to poll the host 22 and pull from the host 22 a list of alerts for active document hold notices 36, including any hold notices 36 that may or may not have been read by the user but were not responded to by the user. A browser of the user device 48 renders the list for display on the user device 48. An example active holds list is indicated generally in FIG. 3H by reference number 380.

In process 124, if selected by the user, the application 54 may use SOAP calls to poll the host 22 and pull from the host 22 a list of alerts for active policy notices 36, including any policy notices 36 that may or may not have been read by the user but were not responded to by the user. A browser of the user device 48 renders the list for display on the user device 48. If in process 126 the user decides to view a notice for which an alert is displayed in process 114, 122 or 124, he/she selects the appropriate notice in the appropriate list. For example, the user may click on an alert 382 in the active holds list 380 to display the corresponding notice.

A user-selected notice is displayed in process 128 as shown in FIG. 3D. For example, in process 130 the mobile application 54 may indicate to the host application 58 that the user-selected notice 36 is selected for display on the mobile device 48, and the host application 58 may flag the user-selected notice 36 as having been seen by the user. In process 132 the application 54 uses SOAP to pass a temporary authorization token to the host 22 and to pull the selected notice 36 from the host 22. In process 134 the application 54 displays the notice 36 on the mobile device 48 via the mobile device 48 browser. The user may then select a link displayed in the notice 36 as a response to the notice 36, which the mobile device 48 sends to the host 22 via the browser.

Before push services may be provided, the mobile device application 54 registers with the host 22 and with the push service 42. The host 22 also registers with the push service 42. When the software application 54 starts up on the mobile device as shown in FIG. 3A, the application 54 checks for registration by the user and the application 54. The user and the mobile device 48 may become registered, e.g., as shown in FIGS. 3E and 3F. There may be other or additional registration procedures, however, used by various organizations.

Referring to FIG. 3E, a registration process 106 may begin by the user registering his/her email address in process 138 and his/her product key (or client id) in process 140. Registration as shown in FIG. 3E may begin automatically upon application startup if the user's status is not “registered.” Additionally or alternatively, registration may be activated by the user selecting a menu option 136 in the context menu as shown in FIG. 3B.

A settings process generally numbered as 150 captures the user's email address and product key (client id) and communicates through web services with the hosted application 58 to determine whether the user is “approved” by the host 22. The host application 58 sends an authentication email message to the email address entered for verification and final activation. The authentication email is sent to authenticate that the user of the mobile device has access to the email address entered in process 138. If the user clicks on a link provided in the authentication email, the user status changes from “unverified” to “pending approval” 152. If the hosted application 58 determines the user's status to be “pending approval” 152, “unverified” 154, “denied” 156 or “revoked” 158, the registration process is refreshed and cycles until the status becomes “approved” 160. If the user status is “approved,” the host application 58 sets an authentication key and assigns user privileges. Upon activation, the process 112 for checking for active alerts may begin as shown in FIG. 3A.

The push notification registration process 110 is shown in FIG. 3F. The mobile application 54 interacts with the push service 42 in process 162 to register the mobile device 48 to receive push notifications. If the device 48 is not approved by the push service 42 to receive push notifications, push notifications will not be sent to the device 48, and the mobile application 54 user might instead proactively open the application 54 to review notices 36. If the mobile device 48 is approved by the push service 42 to receive push notifications, the application 54 receives a device token in process 164 from the push service 42. In process 166 the device token is sent to and stored by the hosted application 58 and associated with the user's email address used in the registration process shown in FIG. 3E.

When the host application 58 issues a new notice 36 for a user, the application 58 uses an email address registered for the user as previously discussed. Notices 36 from the hosted application 58 are addressed to a user's registered email address and a push notification process 170 is invoked as shown in FIG. 3G. In process 172 the hosted application 58 reads the stored device token associated with the user's registered email address. The hosted application 58 in process 174 sends the device token and an appropriate push notification (e.g., “You have a new Hold Notification”) to the push service 42, which in process 176 sends the push notification to the appropriate user device 48. If the user in process 178 chooses to view the associated alert, the mobile application 54 starts in process 102 as previously discussed with reference to FIG. 3A.

It should be noted generally that the use of email by an organization in relation to the sending of notices and receipt of responses is not necessarily foreclosed in various implementations of the disclosure. For example, an email might be used as an informal, supplementary reminder that notices are pending for users to review. It should be understood, however, that the use of email to deliver and/or track implementation notices is obviated in various configurations in accordance with the disclosure, which provide a “closed-circuit” system for sending notices, for tracking receipt and opening of notices, and for checking compliance with the notices.

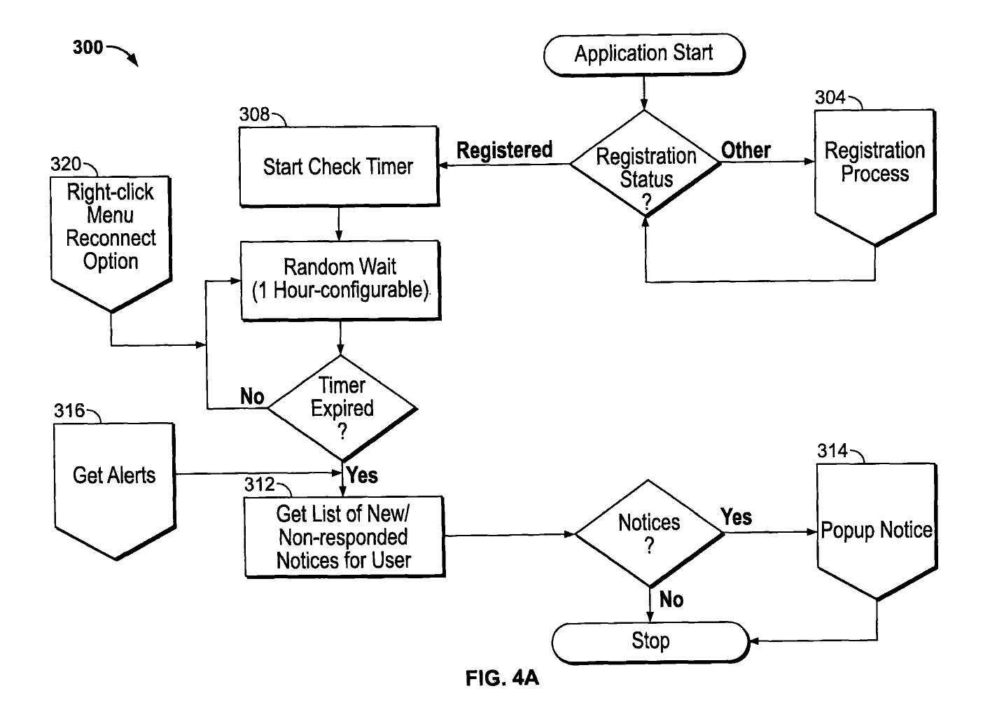

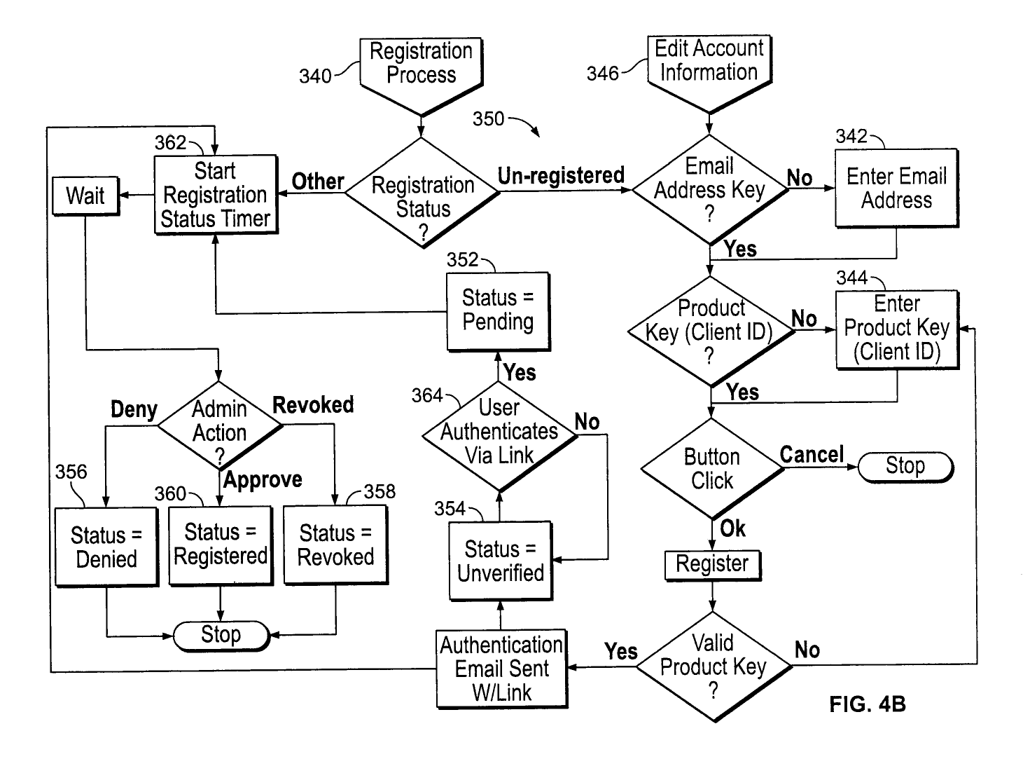

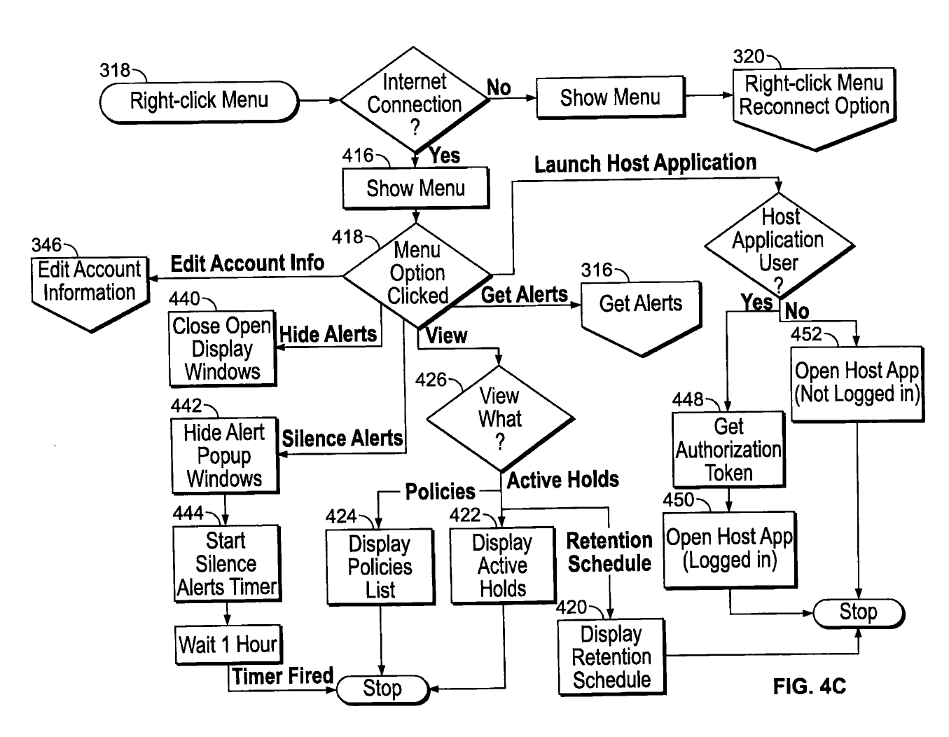

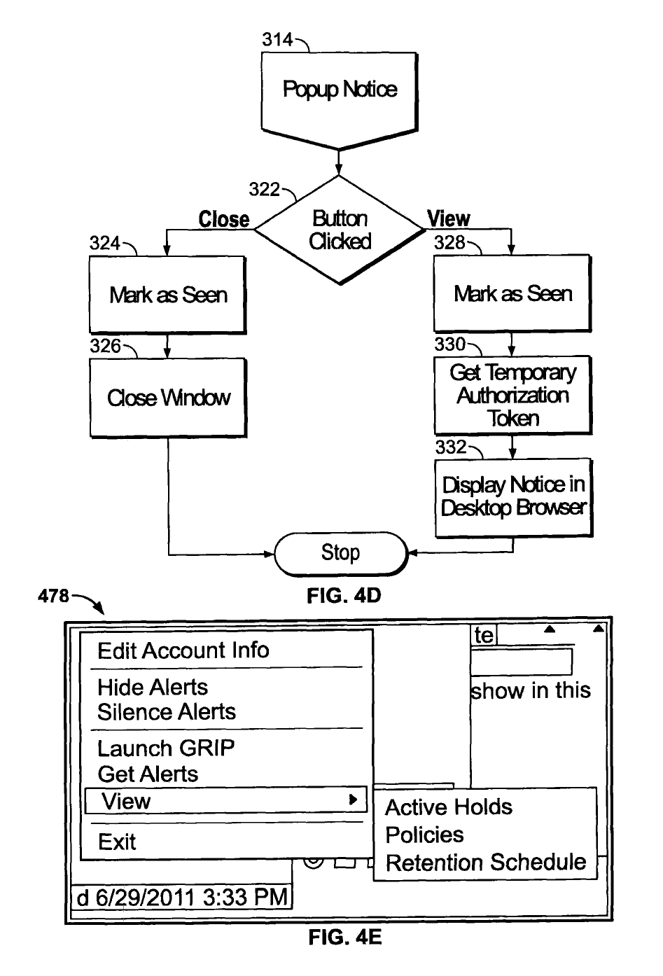

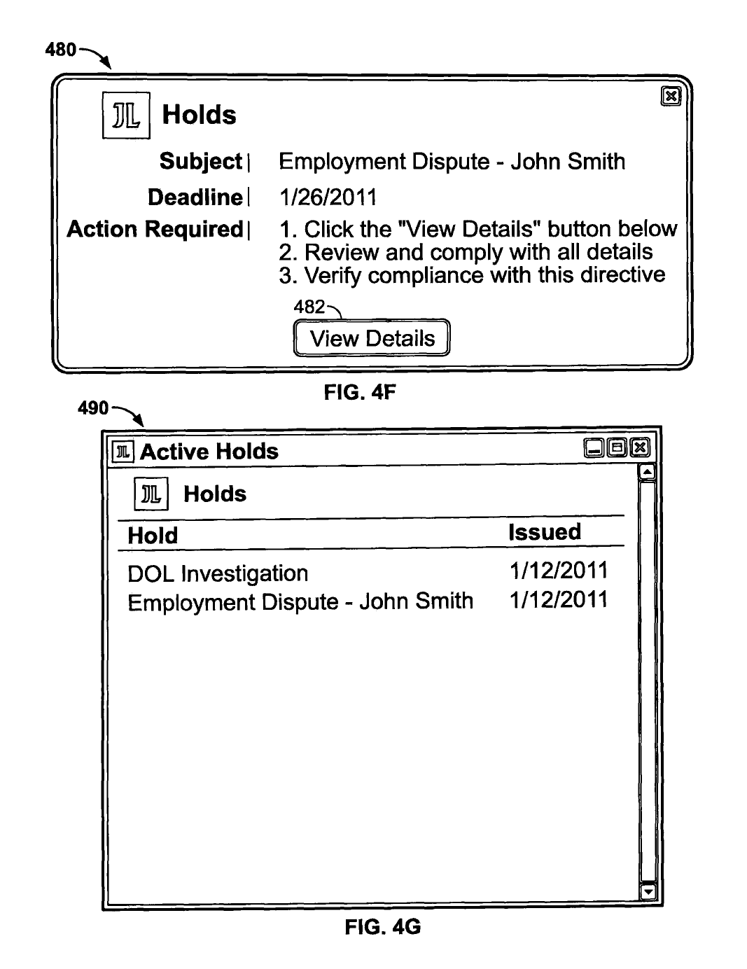

In an implementation indicated generally in FIGS. 4A-4G by reference number 300, a laptop computer 44 is configured as a user device 40. Specifically and for example, the software application 50 resides on the laptop 44 and communicates, through web services, with the host application 58. The laptop application 50 may be written in Microsoft® C#, although other languages could be used. Communication through web services facilitates self-configuring by the software, thereby reducing or eliminating a need to update the software. It should be noted generally that although the present example is described with reference to a laptop computer, the application 50 could reside on a desktop computer or other device having a compatible operating system.

In the present example laptop application 50, two types of timers may be executed: program definition timers and program action timers. One or more program definition timers are static. A program definition timer may be used, e.g., to control the frequency at which a user's registration status is verified. One or more program action timers are variable. Program action timer(s) may be used, e.g., to control optional service(s) (which may be self-configuring) performed by the laptop application 50. Various notice types and reminders can be controlled through such timers.

After the user launches the laptop application 50 as discussed below, the application 50 starts as shown in FIG. 4A. If the user is not registered with the host 22, then a registration process 304 is performed, e.g., as shown in FIG. 4B further described below. If the user is registered, a check timer is set and started in process 308. The time is configurable, e.g., to sixty minutes. The check timer may be set upon initial application startup to avoid collisions that typically may occur within the web services used by the system 20, e.g., when users across organizations start their computers at the same time of the morning. Expiration of the check timer subsequently triggers periodic polling of the host 22 for new and/or non-responded-to alerts. During check timer waiting periods, and as further described with reference to FIG. 4C, the user may right-click on a system tray icon displayed on the laptop 44 to be redirected to a menu (shown in FIG. 4C.) The user in process 320 may right-click on a reconnection option to return to the wait period.

Upon expiration of the check timer, the user device 44 of a registered user polls the host 22 in process 312 to pull any new and/or non-responded-to alerts associated with the email address that has been registered for the user (as discussed below with reference to FIG. 4B.) Any such alerts are displayed in process 314 in a popup as shown in FIG. 4D. An example screen shot of a laptop menu display in accordance with one implementation of the disclosure is indicated generally in FIG. 4E by reference number 478.

As shown in FIG. 4D, when the laptop application 50 pulls an alert from the host application 58, the laptop application 50 renders an alert as a popup near the system tray. An example popup is indicated generally in FIG. 4F by reference number 480. If in process 322 the user closes the popup, then in process 324 the host application 58 marks the alert as having been pulled by (and presumably viewed from) the given user laptop 44, and in process 326 the laptop application closes the popup. If in process 322 the user chooses to click a “View Details” button 482 of the popup to view details of the associated notice, in process 328 the host application 58 marks the notice as having been pulled from the host 22 for display on the given user laptop 44. In process 330 the application 50 obtains a temporary authorization token and pulls the selected notice 36 from the host 22. In process 332 the application 50 renders the notice 36 on the laptop 44 via, e.g., the laptop default browser. The user may then activate a link to select a response to the notice 36, which the laptop 44 sends to the host application 58. The host application 58 flags the notice as having been pulled by the laptop application 54 and records the user's response (if any).

If the user's registration status is anything but ‘approved,’ the user is directed to a registration process shown in FIG. 4B. A registration process 340 may begin by the user registering his/her email address in process 342 and his/her product key (or client id) in process 344. Registration as shown in FIG. 4D may begin automatically upon application startup if the user's status is not “registered.” Additionally or alternatively, registration may be activated by the user selecting a menu option 346 in a context menu as shown in FIG. 4C.

A settings process generally numbered as 350 captures the user's email address and product key (client id) and communicates through web services with the hosted application 58 to determine whether the user is “registered” by the host 22. If the hosted application 58 determines the user's status to be “pending approval” 352, “unverified” 354, “denied” 356 or “revoked” 358, the registration process is refreshed and cycles until the status becomes “registered” 360. A registration timer is set in process 362 after the host 22 sends an authentication email to the email address provided by the user in process 342. The authentication email includes a link for activation by the user to confirm receipt of the authentication email. The registration timer is configured to check the host 22 for the status of the user device 44 as described with reference to processes 352, 356, 358 and 360. If the user device 44 is “approved,” it is given the status “registered” and (although not shown in FIG. 4B) the application 50 is given an authentication key and user privileges. Upon registration, the process 316 for checking for active alerts may begin as shown in FIG. 4A.

As shown in FIG. 4C, the application 50 in process 416 may display a menu of options on the laptop 44 display. An example menu display is indicated generally in FIG. 4E by reference number 478. Referring again to FIG. 4C, in process 418 the user may select from several menu options. In order to provide at least some of the features selectable from the menu, the software application 50 on the laptop 44 communicates with the host 22 via web services to provide the features, including but not limited to scheduling and reporting capabilities. It should be noted generally that menu options could be provided in addition to, and/or in place of, those shown in FIGS. 4C and 4E. Such options could include capabilities cooperatively provided by a user device 40 and the host 22 through web services and web service protocols including but not limited to SOAP.

In process 420, if selected by the user, the application 50 may use one or more SOAP calls to poll the host 22 and pull from the host 22 the organization's current retention schedule. The schedule is rendered by a browser of the laptop 44. In process 422, if selected by the user, the application 50 may use SOAP calls to poll the host 22 and pull from the host 22 a list of alerts for active document hold notices 36, including any hold notices 36 that may or may not have been read by the user but were not responded to by the user. A browser of the laptop 44 renders the list for display on the laptop. An example active holds list is indicated generally in FIG. 4G by reference number 490.

In process 424, if selected by the user, the application 50 may use SOAP calls to poll the host 22 and pull from the host 22 a list of alerts for active policy notices 36, including any policy notices 36 that may or may not have been read by the user but were not responded to by the user. A browser of the laptop 44 renders the list for display on the laptop. If in process 426 the user decides to view a notice for which an alert is displayed in process 316, 422 or 424, he/she selects the appropriate notice in the appropriate list. The selected notice is displayed as previously discussed with reference to FIG. 4D. Laptop menu options also include a process 440 whereby the user may close any open alert popup windows. In process 442, if selected by the user, popup windows for alerts may be hidden for a predetermined time period, e.g., one hour, commenced in process 444 by setting a silence-alerts timer.

The user may launch the host application 58 by selecting a menu option in process 418. If the host application 58 has already registered with the host 22, then the application 58 uses SOAP calls to pass an authorization token to the host 22 in process 448 and to log in with the host 22 in process 450. If the authorization token passed to the host 22 is recognized as a registered administrator of the host application 58, then the host application is opened and logged in. If the authorization token passed to the host 22 is not recognized as a registered administrator of the host application 58, then the host application is opened but is not logged in to the host 22. Registration may then take place as previously discussed with reference to FIG. 4B.

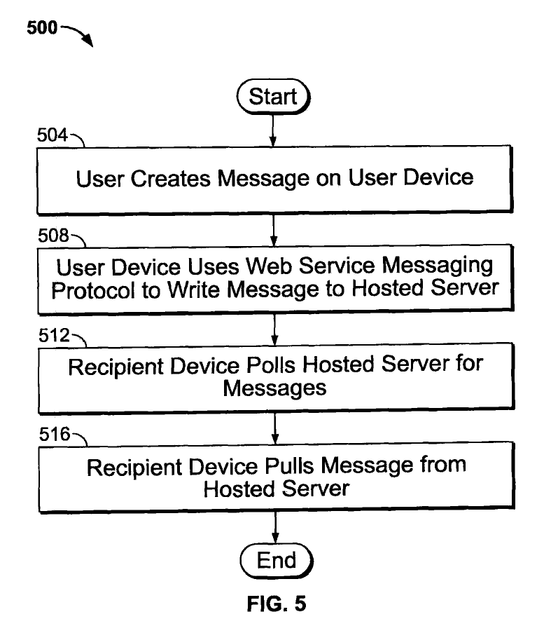

In some configurations a user, e.g., of the system 20 may create a message on a user device 40 and use SOAP or another web service protocol to send the message to the host 22. For example, in addition to (but, in the present example, not in place of) activating a link to send a response to a given notice 36, a user may wish to send to an administrator of the system 20 a response for which no link is provided in a notice 36. One method of sending a message is indicated generally in FIG. 5 by reference number 500. In process 504 a user creates, e.g., on a laptop device 44 or mobile device 48, a message for an intended recipient. In process 508 the user application 50 or 54 formats and sends the message in SOAP to the host 22. The host 22 may associate the message with an email address registered for the intended recipient of the message. In process 512 a user device 40 of the intended recipient of the message uses SOAP to poll the host 22 for messages, e.g., on a periodic basis. The user device 40 of the intended recipient may be, but is not necessarily, a laptop computer 44 or mobile device 48. In process 516 the recipient device uses SOAP to pull the message received by the host 22. A user of the system 20 could use the method 500, for example, to send a question or observation to an administrator of the system 20 regarding various implementation notices 36.

Various systems and methods in accordance with the disclosure can provide direct and secure communication for the delivery of notices to employees throughout an organization. By implementing the foregoing systems and methods, organizations can monitor whether employees have received, read and responded to communications of policies, directives and procedures.

The foregoing user devices and user device applications make it easy and convenient for each employee to keep a close watch on policy and procedure notices he/she receives and to follow up on tasks that he or she is responsible for implementing. When a directive is to be implemented by many people in an organization who happen to be widely dispersed, the user devices and applications provide a way for management to effectively notify the users of such devices and to follow up on how the directive was handled. Such systems and methods are far more reliable and efficient than email, which can easily be ignored, caught in spam filters, or unintentionally deleted. Company managers previously only could assume employees' compliance with policies or procedures in the absence of a way to confirm that company directives were carried out.

In contrast, it is almost impossible for a notice to be lost or deleted in the foregoing system configurations, due to the automatic cooperation between a user device and a hosted server: when the appropriate party opens an alert, the corresponding notice is automatically displayed to that party. If the party does not respond when the notice is displayed, the hosted server flags the notice as active and continues to list it until the party eventually responds to it. The foregoing systems and methods are highly useful for distributing notices to, and gathering responses from, geographically dispersed recipients using laptops, desktops or mobile devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for overseeing the implementation of policies, procedures, and/or directives of an organization, the system comprising:
a host including one or more processors and memory configured to identify parties involved in implementations of policies, procedures, and/or directives of an organization, the host further configured to track statuses of the implementations by (a) issuing implementation notices for access by the identified parties, (b) providing with each notice one or more actions selectable as a response to the notice, and (c) tracking responses by the identified parties; and
a user device associated by the host with one of the identified parties, the user device configured to:
in response to an occurrence of a predefined event, poll the host to determine whether an implementation notice is pending for the associated one of the identified parties and provide an alert if an implementation notice is determined to be pending; and
based on a user response to the alert, display the pending notice via a browser of the user device, and send to the host via the browser a user-selected response, if any, to the pending notice;
the host further configured to leave the pending notice pending unless and until the host receives a user-selected response via one of one or more user-selectable links provided in the pending notice and corresponding to the one or more selectable actions.

2. The system of claim 1, wherein the predefined event comprises an expiration of a timer.

3. The system of claim 1, wherein each of the notices is related to a corresponding one of one or more implementation categories, the one or more implementation categories comprising one or more of the following: a retention schedule, a policy schedule, and a document hold schedule.

4. The system of claim 1, wherein the predefined event comprises a push from a push service, the host further configured to signal the push service to issue the push.

5. The system of claim 1, wherein the user device comprises a mobile device.

6. The system of claim 1, wherein the user device comprises a laptop or desktop computer.

7. The system of claim 1, wherein the user device is further configured to use a web service messaging protocol to send a message to the host for a recipient, the host further configured to, upon being polled by a device associated by the host with the recipient, display the message, via a browser of the device associated by the host with the recipient, to the device associated by the host with the recipient.

8. The system of claim 7, wherein the message relates to one or more of the following: a retention schedule, a policy schedule, and a document hold schedule.

9. The system of claim 1, wherein the host is further configured to confirm, without sending or receiving email: (a) whether the user device opened a given implementation notice, (b) whether the user device closed the given implementation notice, and (c) whether the user device responded to the given implementation notice.

10. A method of overseeing the implementation of policies, procedures, and/or directives of an organization, the method comprising:
identifying parties involved in implementations of policies, procedures, and/or directives of an organization, the identifying performed by a host including a processor and memory;
the host tracking statuses of the implementations by (a) issuing implementation notices for access by the identified parties, (b) including in each notice one or more links by which one of one or more actions is selectable as a response to the notice, (c) tracking responses received from user devices associated with the identified parties and registered with the host, and (d) leaving an issued implementation notice pending unless and until a response to the notice is received through one of the one or more links;
in response to an occurrence of a predefined event, a user device associated with one of the identified parties polling the host to determine whether an implementation notice by the host is pending for the associated one of the identified parties and providing an alert if an implementation notice is determined to be pending;
based on a user response to the alert, the associated user device displaying the notice via a browser of the device;
the associated user device communicating to the host via the browser a response, if any, via a link selected by the user in the displayed notice; and
the host updating a status of the notice based on the responses, if any, to the alert and/or to the notice.

11. The method of claim 10, wherein the predefined event includes one or more of the following: a timer expiration, and a push from a push service.

12. The method of claim 10, wherein the user device includes one or more of the following: a mobile device, a laptop computer, and a desktop computer.

13. The method of claim 10, wherein the polling is performed periodically.

14. The method of claim 10, further comprising:
the user device sending a message to the host for a recipient via a web service messaging protocol; and
the host, upon being polled by a device associated by the host with the recipient, displaying the message to the device associated by the host with the recipient via a browser of the device associated by the host with the recipient.

15. A system for overseeing the implementation of policies, procedures, and/or directives of an organization, the system comprising:
a host including one or more processors and memory configured to identify parties involved in implementations of policies, procedures, and/or directives of an organization, the host further configured to track statuses of the implementations by (a) issuing implementation notices for access by the identified parties, (b) including in each notice one or more links by which one of one or more actions is selectable as a response to the notice, (c) tracking responses by the identified parties, and (d) leaving an issued implementation notice pending unless and until a response to the notice is received via one of the links; and
a user device associated by the host with one of the identified parties, the user device configured to:
in response to an occurrence of a predefined event, poll the host to determine whether an implementation notice is pending for the user device and provide an alert if an implementation notice is determined to be pending; and
based on a user response to the alert, display the pending notice via a browser of the user device, and transmit to the host via the browser and one of the links a user-selected response, if any, to the pending notice.

16. The system of claim 15, wherein a given notice corresponds to one of the following: a retention schedule, an active holds list, and an active policies list.

17. The system of claim 15, wherein the alert identifies an implementation category of the pending notice.

18. The system of claim 15, wherein the alert comprises a popup.

19. The system of claim 15, wherein the polling of the host is performed periodically.

20. The system of claim 15, wherein the user device is further configured to use a web service messaging protocol to send a message to the host for a recipient, the host further configured to, upon being polled by a device associated by the host with the recipient, display the message, via a browser of the device associated by the host with the recipient, to the device associated by the host with the recipient.
